(19) United States
(12) Patent Application Publication
(10) Pub. No.: US 2004/0013827 A1
(43) Pub. Date: Jan. 22, 2004

(54) Thermally-sealable multilayer film for resealable packages

(76) Inventors: Wilhelm Zuser, St. polten (AU); Klaus Gerstl, Hofstetten (AU); Adolf Schedl, Obergrafendorf (AU); Rainer Huber, St. Polten (AU); Lambert Nekula, Hofstetten (AU); Franz Reiterer, Getzersdorf (AU)

Correspondence Address: YOUNG & THOMPSON, 745 SOUTH 23RD STREET 2ND FLOOR, ARLINGTON, VA, 22202

(21) Appl. No.: 10/275,207

(22) PCT Filed: Apr. 26, 2001
(86) PCT No.: PCT/AT01/00126

(30) Foreign Application Priority Data
May 4, 2000 (AT) A 780/2000

(51) Int. Cl. F16L 1/00

(52) U.S. Cl. 428/34.1

(57) ABSTRACT

A thermally-sealable multilayer film, for packages which may be resealed after opening, includes an outer layer and a support layer, with a thermally-sealable layer on the side facing the packaged material. A self-adhesive layer made from pressure sensitive adhesive is provided between the support layer and the outer layer. The support layer has weakening lines, which define an opening for the removal of packaged material. For resealing a container, by using the thermally-sealable multilayer film, the user may simply open the defined opening for removal of the contents of the container, by application of an opening force and then reseal the container, by pressing the opened outer layer on to the self-adhesive layer. The above process may be repeated several times, until all the contents of the container are used, whereby the above are protected from possible contamination.

### TECHNICAL AREA

The invention relates to a thermally-sealable multilayer film for packages which can be resealed after opening, consisting of an outside layer and a support layer which has a thermally-sealable layer on its side facing the packaged material. The invention relates furthermore to use of these thermally-sealable multilayer films for sealing food containers such as yoghurt cups.

### PRIOR ART

Thermally-sealable multilayer films are used for example for sealing of food containers. Here it has been found to be disadvantageous that the packages cannot be resealed at all after opening and if so, not by simple joining by hand.

The resealability of food containers is however a demand which is becoming more and more frequent by the consumer. This is because containers are becoming larger and larger so that the consumer is forced to remove their contents in portions. If the intention is to avoid loss of flavoring substances for nonresealable packages or fouling of the container contents, there would have to be a separate cover, for example in the form of an additional plastic slip lid. This is however involved, on the one hand, and on the other hand these slip lids do not have the necessary reliable seal. Since these slip lids in most cases have different material compositions in contrast to thermally-sealable multilayer films, this furthermore leads to disposal problems.

Thus the object of the invention is to make available thermally-sealable multilayer films of the initially mentioned type for sealing of food containers, which can be repeatedly resealed by hand after first-time opening.

### DESCRIPTION OF THE INVENTION

This object is achieved by means of a thermally-sealable multilayer film of the initially mentioned type as claimed in the invention in that between the support layer and the outside layer there is a self-adhesive layer of pressure-sensitive adhesive and that the support layer has weakening lines which define an opening for removal of the packaged material.

Advantageous and preferable embodiments of the multilayer film as claimed in the invention are the subject matter of the dependent claims 2 to 17.

The invention furthermore relates to use of the aforementioned thermally sealable multilayer film as claimed in the invention for sealing of food containers, such as yoghurt cups which are opened by means of an opening aid, preferably a pull tab, such that during opening within the support layer according to the weakening lines an opening for removing the package contents is formed which can be reclosed by means of the pressure-sensitive adhesive layer.

### EMBODIMENTS OF THE INVENTION

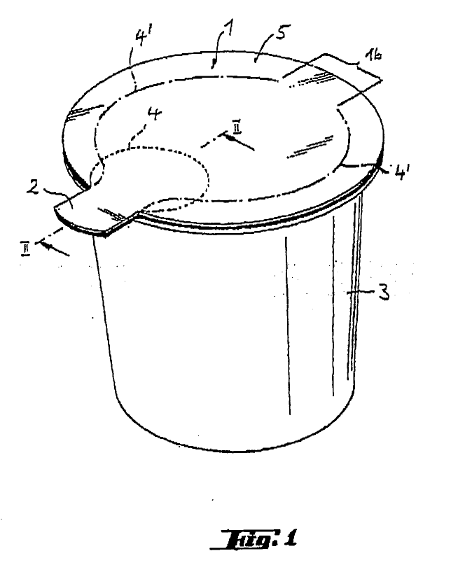

The invention is detailed at this point using FIGS. 1 to 6 and using embodiments.

FIG. 1 shows the use of the thermally-sealable multilayer film 1, that is, the use as claimed in the invention, for sealing a container 3 in the closed state.

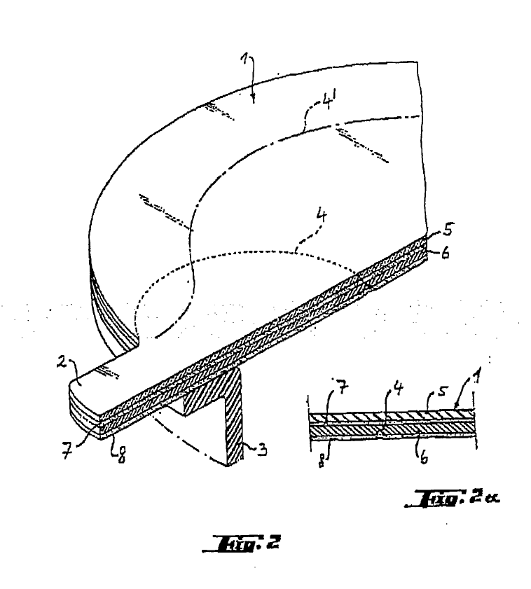

FIG. 2 shows possible embodiments of a thermally-sealable multilayer film 1 as claimed in the invention, FIG. 2a showing the area of the weakening lines in the form of notches in a section.

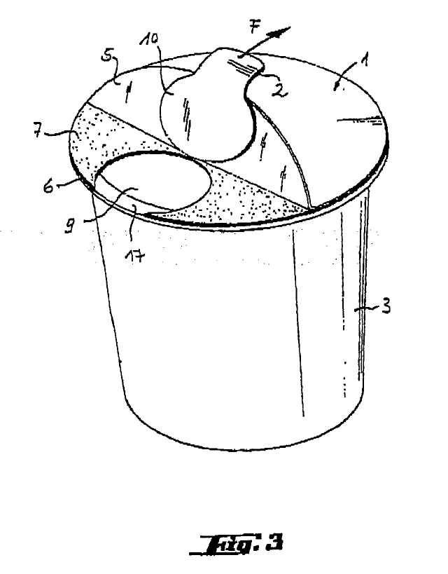

FIG. 3 shows a thermally-sealable multilayer film 1 as claimed in the invention after partially opening the container 3.

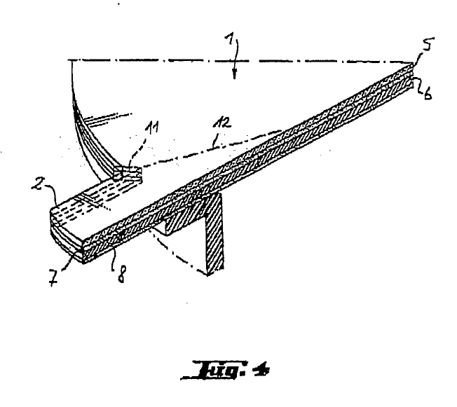

FIG. 4 shows a thermally-sealable multilayer film 1 with weakening lines in the form of slightly punched-out areas.

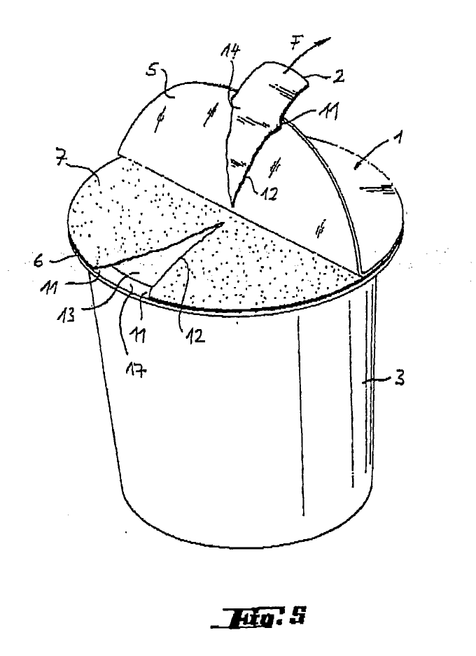

FIG. 5 shows the use of a thermally-sealable multilayer film 1 as claimed in the invention for sealing of containers 3, a somewhat V-shaped opening for removing the package contents being shown in the partially opened state.

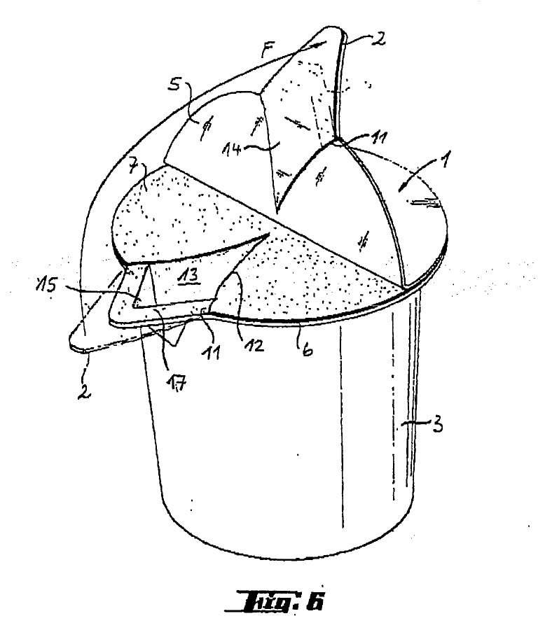

FIG. 6 shows the use of a thermally-sealable multilayer film 1 as claimed in the invention as shown in FIG. 5 on a container 3 with a spout-shaped pouring device.

The thermally-sealable multilayer film as claimed in the invention with respect to the support layer can be produced from a plastic film or a plastic film composite. The plastics are chosen from the group polypropylene, polyethylene, polyamide and polyethylene terephthalate. The thickness of the layer of plastic film is preferably in the range from roughly 30 to 250 microns. When using a film composite the layer thickness is in the range from roughly 50 to 250 microns. The film composite is produced for example by coextrusion so that a composite is formed which consists of two or more layers.

The thermally-sealable multilayer film as claimed in the invention with respect to the support layer can also be produced from an aluminum foil with a tensile strength of for example 50 to 200 N/mm². The thickness of the aluminum foil is for example in the range from 10 to 50 microns, preferably 20 to 40 microns. Its surface structure can be smooth or embossed. The embossed surface structure makes it possible for the thermally-sealable multilayer film, if it is stacked in the form of cover elements for food containers, to be more easily unstacked after storage in a stack. But here the embossing step for preparing the embossed surface structures often leads to unwanted side effects, such as to destruction of a print image which may be present.

The multilayer film as claimed in the invention can furthermore be provided with a surface-rough coating on its support layer, specifically on the surface side facing the packaged material. The surface roughness can be produced for example by adding grainy fillers, a roughness of at least 1 micron being produced. Furthermore it is possible to form the surface-rough coating in the form of a printed image which has spacers arranged in a grid. In doing so, in a printing process which is easy to carry out the spacers can be formed directly on the support layer using a correspondingly shaped print roller. The print rollers are shaped such that coating thicknesses from 1 to 30 microns, and at the sites located in a grid, coating thicknesses from 4 to 100 microns, preferably 4 to 15 microns, arise which are formed by the depressions corresponding to the shape of the grid in the surface of the print roller.

The pressure-sensitive adhesive layer 7 is applied to the support layer 6 which has been pretreated in this way, as is shown in FIG. 2, on the side facing away from the packaged material. The pressure-sensitive cements are solely food-compatible formulations such as softener-free polymer dispersions based on acrylic acid copolymers in water. Then, for example in conventional lining stations, connection to the outside layer 5 takes place. The outside layer 5 consists for example of a transparent, heat-resistant plastic film.

Furthermore it is also possible to apply the pressure-sensitive cement 7 to the outside layer 5, its being applied on the side of the outside layer facing the packaged material.

Then the side of the support layer 7 facing the packaged material is provided with the thermally sealable layer 8. It can consist for example of a thermally sealable lake which is applied in a conventional coating station. Furthermore it is possible to form the thermally-sealable layer 8 as an extrusion coating.

At this point, by embossing or punching, the weakening lines 4, 4′ are produced for forming the opening for removing the container contents. As shown in FIG. 2, the weakening lines 4, 4′ run in a circular arc, the weakening lines 4′ for the most part running continuously and the weakening lines 4 for the most part running with interruptions.

In another inventive version as claimed in the invention, as shown in FIG. 4, the weakening lines are made in the form of slight punches 11 in the support layers made by the corresponding punching tools. They form, as is shown in FIG. 5, the starting point for the continued tearing lines 12 for forming the roughly V-shaped opening 13 for removing the container contents. At the same time, by punching out of the thermally-sealable multilayer film, cover elements are formed, preferably with opening aids, such as pull tabs.

Their use for sealing containers is detailed using FIGS. 1, 3, 5 and 6.

In FIG. 3 there is a circular opening for removing the container contents. It is defined by there being roughly circular weakening lines 4 in the support layer 6 of the multilayer film. If at this point the consumer grasps the pull tab 2 of the thermally-sealable multilayer film and pulls it in the direction of the arrow F, in the cup edge area 17 the adhesive force is overcome. Consequently, by further application of force the adhesive force of the self-adhesive layer 7 is overcome and the outside layer 5 is withdrawn from the support layer 6. In doing so the support layer 6 begins to tear along the weakening lines 4 such that the residue 10 of the support layer remains adhering on the outside layer 5. Thus a circular opening is formed for removal of the container contents. This opening 9 can be resealed by applying pressure in the direction opposite the force F by the consumer's bringing the outside layer 5 to the self-adhesive layer 7 and pressing on it.

If the weakening lines 4′, as shown in FIG. 1, are interrupted in the area 16 vis-a-vis the pull tab 2, the consumer can reseal the container 3 even after completely detaching the multilayer film 1.

In FIG. 5 the use of a thermally-sealable multilayer film 1 for sealing packages, such as yoghurt cups 3, is likewise shown, its being present in the partially opened state. The representation as shown in FIG. 5 differs from that as shown in FIG. 3 in that the opening for removing the container contents is roughly V-shaped. This V-shaped opening 13 is formed by the consumer removing the outside layer 5 together with the support layer residue 14 from the self-adhesive layer 7 by pulling on the pull tab 2. Beforehand in this case the adhesive force acting in the cup edge area 17 must also be overcome. As force continues to be applied the support layer 6 begins to tear proceeding from the slight punches 11 along the lines 12 so that a roughly V-shaped support layer residue 14 remains adhering to the outside layer 5. If at this point, by pressing in the opposite direction to the arrow F the outside layer 5 is in turn brought up to the self-adhesive layer 7 and pressed onto it, the V-shaped removal opening 13 can be resealed.

In the embodiment from FIG. 6 this opening process is carried out analogously to FIG. 5, with the difference that the cup 3 from FIG. 6 has a spout-shaped pouring device 15.

Here the pull tab 2 is matched to the shape of the pouring device 15 and projects over it in order to enable easy gripping. Furthermore, here in the cup edge area 17 there is also a corresponding sealing seam which ensures air-tight sealing of the packaging. To overcome the adhesive force of the sealing seam the pull tab 2 is pulled in the direction of the arrow F. Further opening takes place as described using FIG. 5. After partially pouring out the conventionally thin liquid container contents, such as coffee, the V-shaped support layer residue 14 can be stuck on the V-shaped pouring device 15 by means of the self-adhesive layer 7 by contact pressure so that the package is resealed and can be stored for further use.

### COMMERCIAL APPLICABILITY

By using the thermally-sealable multilayer film as claimed in the invention in the form of cover elements it is possible to seal containers for foods, for example yoghurt, airtight. Here it is possible to open this container entirely or partially and even after opening, due to the formation of the multilayer film as claimed in the invention, to reseal it. This resealing capacity is enabled by the fact that between the support layer 6 and the outside layer 5 there is a self-adhesive layer 7 from which the outside layer 5 is removed when opening with the formation of a corresponding opening for removing the container contents, but after complete or partial opening and after removal it is again brought to the support layer 6 and is pressed onto it. In this way the container is sealed so well that at least up to complete removal of the container contents they are protected against dirt.

In summary, one embodiment of the invention can be described for example as follows.

A thermally sealable multilayer film 1 for packages 3 which can be resealed after opening consists of an outside layer 5 and a support layer 6 which has a thermally-sealable layer 8 on the side facing the packaged material. Between the support layer and the outside layer there is a self-adhesive layer 7 of pressure-sensitive adhesive. The support layer 6 has weakening lines 4, 4′, 11 which define an opening 9, 13 for removing the packaged material. When using the thermally-sealable multilayer film 1 as claimed in the invention for sealing a container 3 it is easily possible for the consumer on the one hand to form a correspondingly defined opening 9, 13 for removing the container contents by applying a peeling force and on the other hand to reseal the container 3 by pressing the removed outside layer 5 onto the self-adhesive layer 7. This process can be repeated several times until the all container contents have been consumed, their being protected against any fouling.

1. Thermally-sealable multilayer film (1) for packages (3) which can be resealed after opening, consisting of an outside layer (5) and a support layer (6) which has a thermally-sealable layer (8) on its side facing the packaged material, characterized in that between the support layer (6) and the outside layer (5) there is a self-adhesive layer (7) of pressure-sensitive adhesive and that the support layer has weakening lines (4, 4′, 11) which define an opening (9, 13) for removal of the packaged material.

2. Thermally-sealable multilayer film as claimed in claim 1, wherein the opening (9) is defined by notches (4, 4′).

3. Thermally-sealable multilayer film as claimed in claim 2, wherein the notches run continuously or with interruptions.

4. Thermally-sealable multilayer film as claimed in claim 2 or 3, wherein the opening (9) has the shape of a circle, the arc of a circle, or an ellipse.

5. Thermally-sealable multilayer-film as claimed in one of claims 1 to 4, wherein the multilayer film has an opening aid, preferably a pull tab (2).

6. Thermally-sealable multilayer film as claimed in claim 5, wherein on either side on the opening aid there are slight punches (11) in the support layer (6) which define a roughly V-shaped opening (13) by continued tearing of the support layer material.

7. Thermally-sealable multilayer film as claimed in one of claims 1 to 6, wherein the outside layer (5) is a transparent, heat-resistant plastic film.

8. Thermally-sealable multilayer film as claimed in one of claims 1 to 6, wherein the outside layer (5) is a printed composite of aluminum foil and/or paper and/or plastic film, preferably a metal-coated plastic film.

9. Thermally-sealable multilayer film as claimed in one of claims 1 to 8, wherein the support layer (6) is a plastic film or a plastic film composite.

10. Thermally-sealable multilayer film as claimed in claim 9, wherein the plastics of the plastic film or the plastic film composite are chosen from the group polypropylene, polyethylene, polyamide and polyethylene terephthalate.

11. Thermally-sealable multilayer film as claimed in one of claims 1 to 8, wherein the support layer (6) is an aluminum foil.

12. Thermally-sealable multilayer film as claimed in claim 11, wherein the aluminum foil on its side facing the container interior has a smooth or embossed surface structure.

13. Thermally-sealable multilayer film as claimed in one of claims 1 to 12, wherein the support layer (6) on its side facing the container interior has a surface-rough coating with a peak to valley height from 1 to 100 microns.

14. Thermally-sealable multilayer film as claimed in claim 13, wherein the surface-rough coating is present in the form of a surface-rough imprint.

15. Thermally-sealable multilayer film as claimed in claim 14, wherein the surface-rough imprint has spacers arranged in a grid.

16. Thermally-sealable multilayer film as claimed in claim 15, wherein the spacers have a height from 1 to 100 microns, preferably from 4 to 15 microns.

17. Thermally-sealable multilayer film as claimed in one of claims 13 to 16, wherein the peak to valley height of the surface-rough coating is produced by adding a grainy material.

18. Thermally-sealable multilayer film as claimed in one of claims 1 to 17 for sealing of food containers, such as yoghurt cups (3) which are opened by means of an opening aid, preferably a pull tab (12), such that during opening within the support layer (6) according to the weakening lines (4, 4′, 11) an opening (9, 13) for removing the package contents is formed, which opening (9, 13) can be reclosed by the pressure-sensitive adhesive layer (7).

19. Thermally-sealable multilayer film as claimed in claim 18, wherein the food container (3) is one with a preferably spout-shaped pouring device (15).
